(19) United States
(12) Patent Application Publication
(10) Pub. No.: US 2018/0022579 A1
(43) Pub. Date: Jan. 25, 2018

(54) ARRANGEMENT FOR ADJUSTING THE TAUTNESS OF A TRACTION MEMBER OF AN ELEVATOR

(71) Applicant: Kone Corporation, Helsinki (FI)

(72) Inventors: Markku HAAPANIEMI, Helsinki (FI); Matti Rasanen, Hyvinkaa (FI); Janne Mikkonen, Jarvenpaa (FI); Esko Aulanko, Kerava (FI)

(73) Assignee: Kone Corporation, Helsinki (FI)

(21) Appl. No.: 15/720,269

(22) Filed: Sep. 29, 2017

Related U.S. Application Data
(63) Continuation of application No. PCT/FI2015/050286, filed on Apr. 27, 2015.

(51) Int. Cl. B66B 7/10; B66B 11/00; B66B 11/04

(52) U.S. Cl. CPC B66B 7/10; B66B 11/0476; B66B 11/009

(57) ABSTRACT

The object of the invention is an arrangement for adjusting the tautness of a traction member of an elevator, which arrangement comprises an elevator car and a compensating weight, which are for their part connected to support the elevator car by the aid of a suspension member, such as a rope or belt, and also a hoisting machine provided with a traction sheave, and one traction member, such as a belt, which is adapted to transmit the rotational movement of the traction sheave into movement of the elevator car and of the compensating weight, and also a tension control means, which is arranged to adjust the magnitude of the tension forces exerted on the suspension member and on the traction member. The arrangement comprises a tensioning means connected to the traction member, and the tension control means is connected to that part of the traction member that is on the side of the compensating weight with respect to the traction sheave, and the tensioning means is connected to that part of the traction member that is on the side of the elevator car with respect to the traction sheave.

This application is a continuation of PCT International Application No. PCT/FI2015/050286 which has an International filing date of Apr. 27, 2015, the entire contents of which are incorporated herein by reference.

The object of the present invention is an arrangement as defined in the preamble of claim 1 for adjusting the tautness of a traction member of an elevator.

In some elevator arrangements the suspension members, such as the suspension ropes, of an elevator car and the traction members of the elevator car are separate from each other. Often, in this case, for practical reasons the hoisting machine is disposed on the base of the elevator hoistway, or close to the bottom part of the elevator hoistway, and e.g. toothed belts, or other belts suited to the purpose, can function as traction members, which are fitted below the elevator car and one or more compensating weights or counterweights. In this type of elevator the stresses exerted on the suspension members and on the traction members change as, among other things, the load in the elevator car changes. From the viewpoint of the proper functioning of the elevator, it is desirable for the distribution of the stresses of the suspension members and traction members to remain suitable and for the traction members to remain suitably taut. Over time elongations easily occur in traction members, especially if the travel height of the elevator is large, in which case the correct tautness is very important. Also changes in temperature affect the length of traction members. Changes in the length of traction members must be compensated in some way in order for the traction members to remain at a suitable tautness. Traction members may not be too loose nor may they be too taut because otherwise they, or other parts of the elevator, can become damaged. An apparatus or arrangement suited to the purpose is therefore needed for adjusting the tautness of the traction members of an elevator.

According to what is known in the art, the tautness of the traction members of elevators is adjusted by means of, inter alia, an arrangement functioning with an electric motor. The adjustment of the tautness can be made e.g. at certain intervals of time or on the basis of the measuring data of a separate sensor. A problem with making an adjustment at certain intervals of time is that the traction members can be at the wrong tautness for a long time between adjustments. An arrangement based on a tension sensor solves this problem, but is for its part a more complex and more expensive solution. A drawback in performing the tensioning of the traction members with an electric motor is also that this requires its own electricity supply, along with the cables and protections associated with it. The apparatus comprised in such an arrangement can also be rather large in size and heavy in weight, and if it is disposed on the elevator car it will increase the mass of the car.

U.S. Pat. No. 5,437,347 presents a solution by means of which the tautness of the traction members of an elevator is adjusted in an elevator wherein the traction members and suspension members are separate from each other. In this solution a rocker means is fixed to the counterweight or to the elevator car, to which rocker means both the suspension members and the traction members are fixed at one of their ends. The rocker means is hinged to the counterweight or to the elevator car, and the suspension members and traction members are fixed to the rocker means at different distances from its fulcrum. In this solution the counterweight of the elevator is used for maintaining the tension of the traction members and for compensating changes in their length. The solution has the problem, however, that its operating range is not very large, owing to which it is not necessarily able the keep the traction members sufficiently taut if the fluctuation range of the length of the traction members is, e.g. as a result of elongation, large. The adjustment margin for compensating elongation is thus too small in the solution described in the US patent. This can be a problem particularly in elevators with large travel heights, in which the elongations are long.

The aim of the present invention is to eliminate the aforementioned drawbacks and achieve an inexpensive and easy-to-implement arrangement in an elevator, in which the suspension members and the traction members are separate from each other, and in which arrangement the compensation of the elongation of the traction members and suspension members can be arranged to be automatic in such a way that the elevator car is all the time in balance regardless of the load or of different elongation of the suspension members and traction members, and the traction members are at a suitable tautness. The arrangement according to the invention is characterized by what is disclosed in the characterization part of claim 1. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

One advantage of the solution according to the invention is that by means of it the traction members of an elevator can be kept at a suitable tautness automatically in an elevator in which the traction members are separated from the suspension members. Another advantage of the solution is its large operating range, owing to which even large fluctuations in the length of the traction members can be compensated. A further advantage of the solution is that it is simple and inexpensive to implement.

In the following, the invention will be described in more detail by the aid of some examples of its embodiment with reference to the simplified and diagrammatic drawings attached, wherein

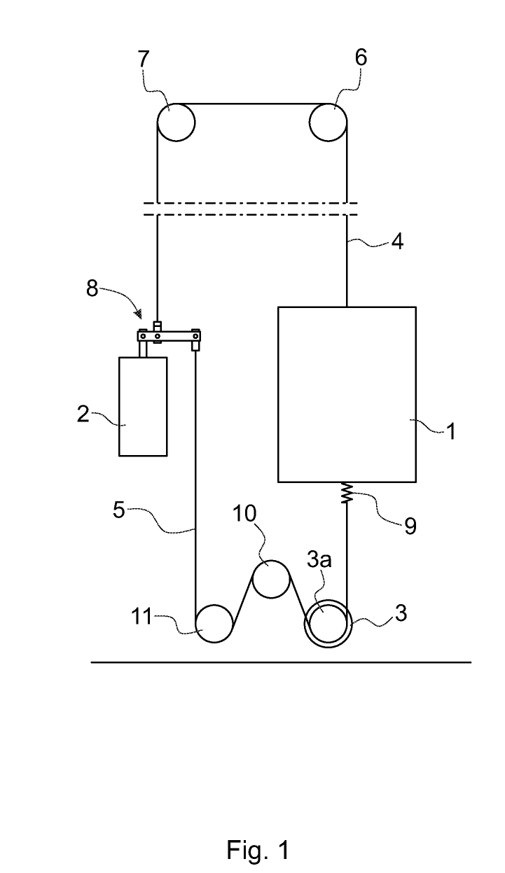

FIG. 1 presents a simplified and diagrammatic side view of an elevator having a traction ratio of 1:1, and in which one embodiment of the arrangement according to the invention is used,

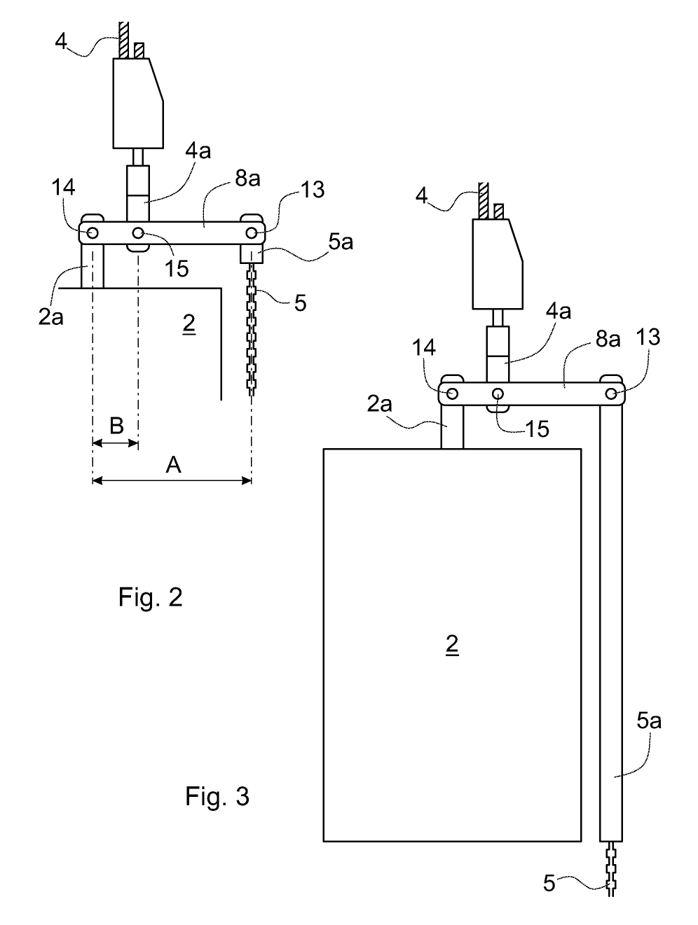

FIG. 2 presents a magnified side view of a rope suspension comprised in the arrangement according to the invention, at the top end of the compensating weight,

FIG. 3 presents a magnified side view of a second suspension of the elevator car and of the compensating weight, said suspension comprised in the arrangement according to the invention, at the top end of the compensating weight,

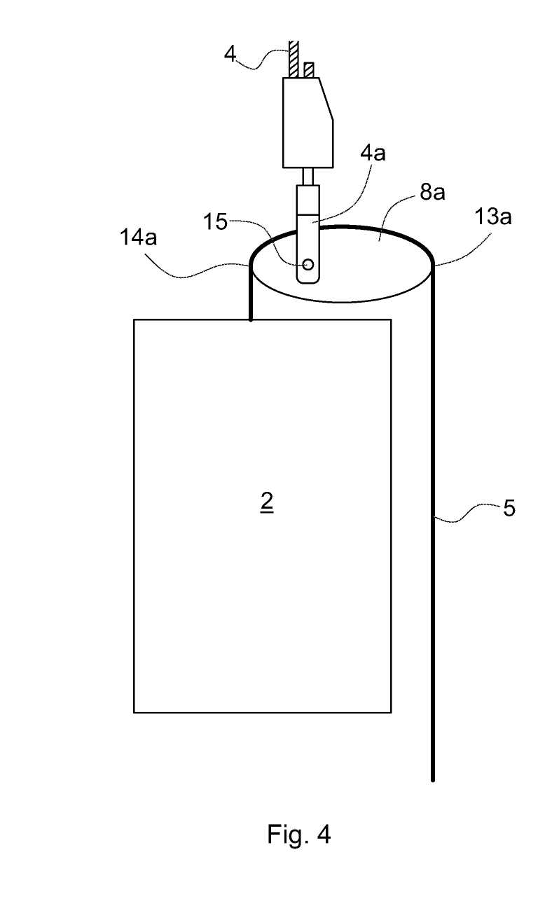

FIG. 4 presents a magnified side view of a third suspension of the elevator car and of the compensating weight, said suspension comprised in the arrangement according to the invention, at the top end of the compensating weight,

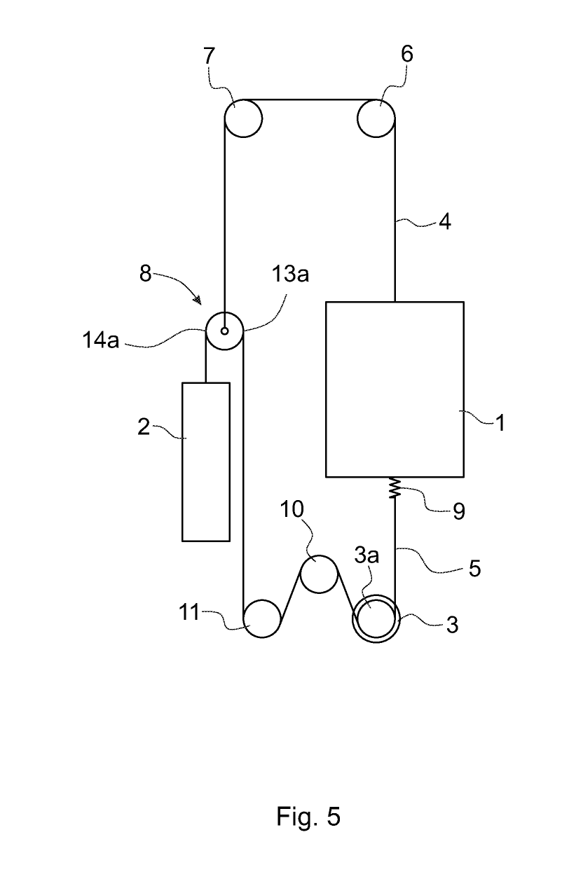

FIG. 5 presents a simplified and diagrammatic side view of an elevator having a traction ratio of 1:1, and in which another different suspension of the elevator car and of the compensating weight is used, said suspension being comprised in the arrangement according to the invention and being at the top end of the compensating weight, and

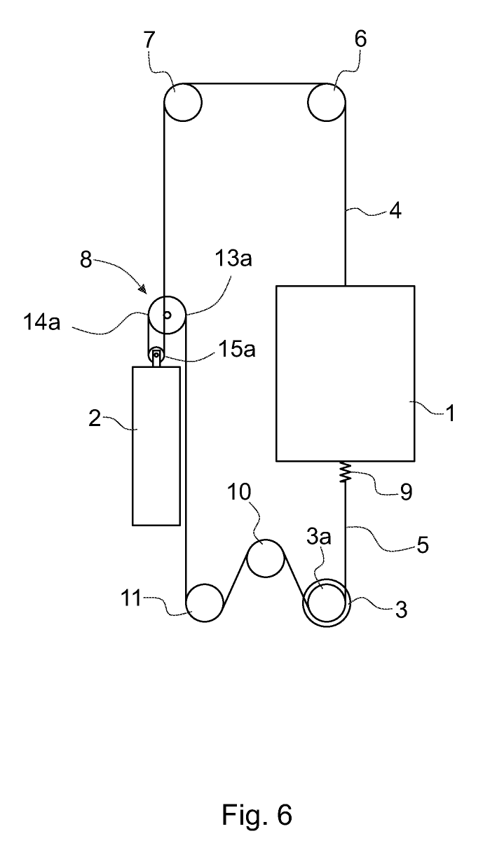

FIG. 6 presents a simplified and diagrammatic side view of an elevator having a traction ratio of 1:1, and in which yet another different suspension of the elevator car and of the compensating weight is used, said suspension being comprised in the arrangement according to the invention and being at the top end of the compensating weight.

The elevator arrangement made possible by the arrangement according to the invention comprises at least an elevator car 1 adapted to move reciprocally in an elevator hoistway and at least one or more compensating weights 2, which are for their part connected to support the elevator car 1 by means of suspension members 4, such as belts or ropes, and also by means of diverting pulleys 6 and 7 e.g. mounted on bearings in the top part of the elevator hoistway. Whenever hereinafter only one compensating weight is mentioned, the simultaneous meaning intended is one or more compensating weights, or alternatively one or more counterweights. In addition, the arrangement according to the invention comprises a hoisting machine 3 that is provided with at least one traction sheave 3a, or with a corresponding means, and is in a machine station disposed in the bottom part of the elevator hoistway, and at least one or more traction members 5, such as a belt or rope, which is adapted to transmit the rotational movement of the traction sheave 3a into linear movement of the elevator car 1 and of the compensating weight 2. Whenever hereinafter only one traction member 5 is mentioned, the simultaneous meaning intended is one or more parallel traction members, such as one or more toothed belts, V-belts, flat transmission belts or traction ropes.

The traction member 5 in the arrangement according to the invention is separated from the suspension members 4, and the traction member 5 together with the suspension members 4 and elevator car 1 and compensating weight 2 form an essentially closed loop in which the tautness of at least the traction member 5 is monitored and the tautness is kept at the desired level independently of different loads and elongations. Characteristic to the invention, and common to all the different embodiments of the invention, is that the compensating weight 2 is connected e.g. by means of a traction member 5 provided with essentially spring tensioning or constant-force tensioning to the elevator car 1 via the hoisting machine 3.

FIGS. 1 and 2 present a simplified and diagrammatic side view of an elevator in which one embodiment of the solution according to the invention is used. FIG. 2 presents a magnified view of the suspension solution according to FIG. 1 at the top end of the compensating weight 2. The elevator comprises at least an elevator car 1 and at least one compensating weight 2, as well as a hoisting machine 3 plus traction sheave 3a arranged to move the elevator, a suspension member 4 and a traction member 5. There can be one suspension member 4 and traction member 5 or a number of them side by side. The suspension member 4 is fixed at its first end to the top part of the elevator car 1, from where it is guided upwards to pass around the top of the diverting pulleys 6 and 7 disposed in the top part of the elevator hoistway. After having passed around the top of the diverting pulley 7 the suspension member 4 is led downwards to a tension control means 8 fitted near the compensating weight 2, to which tension control means the suspension member 4 is fixed at its second end.

The traction member 5 is fixed at its first end to a tensioning means 9 that is on the bottom part of the elevator car 1 and provides a constant tensioning force, from where the traction member 5 is led downwards to the hoisting machine 3. The traction member 5 is arranged to pass around the bottom of the traction sheave 3a of the hoisting machine 3, after which over the first diverting pulley 10 and onwards under the second diverting pulley 11, from where upwards to the tension control means 8, to which the traction member 5 is fixed at its second end. The traction member 5 is e.g. a toothed belt, in which case on the traction sheave 3a is toothing that matches the toothing of the traction member 5. The compensating weight 2 is fixed at its lifting point to the tension control means 8 by the aid of its own fixing means 2a.

The tension control means 8 is a means that functions as a lever, having e.g. a bar-shaped or rod-shaped frame part 8a, the traction member 5 of the elevator being fixed at its second end to the fixing point 13 at the first end of said frame part via a fixing means 5a, and the compensating weight 2 being fixed at its lifting point to the fixing point 14 at the second end of said frame part via a fixing means 2a. The suspension member 4 is fixed at its second end via a fixing means 4a to a suitable fixing point 15 between the fixing points 13 and 14, to between the first and second end of the frame part 8a of the tension control means 8. The fixing means 2a, 4a and 5a are fixed to the fixing points 13, 14 and 15 on the frame part 8a, e.g. via hinges or shaft extensions suited to the purpose.

The fixing point 15 of the fixing means 4a of the suspension member 4 between the fixing points 13 and 14 is selected in such a way that between the suspension member 4 and the traction member 5 the correct lever ratio A/B is obtained, in which lever ratio the length of the lever arm A is the distance of the fixing point 13 of the traction member 5 of the elevator from the fixing point 14 of the compensating weight 2, and the length of the lever arm B is the distance of the fixing point 15 of the suspension member 4 of the elevator from the fixing point 14 of the compensating weight 2. This lever ratio A/B acts directly on the magnitude of the forces exerted on the suspension member 4 and on the traction member 5.

FIG. 3 presents a suspension solution and tension control solution that is otherwise similar to those in FIGS. 1 and 2, but in this solution the fixing means 5a of the traction member 5 is longer than that in the solution presented by FIGS. 1 and 2 and extends from its fixing point 13 downwards to the level of the bottom edge of the compensating weight 2 or to near the bottom edge. One advantage in this case is the easy fixing of the second end of the traction member 5 to the fixing means 5a, in which case installation and servicing of the elevator arrangement is made easier in this respect.

FIG. 4 presents a magnified side view of one third suspension of the elevator car 1 and of the compensating weight 2, said suspension comprised in the arrangement according to the invention, at the top end of the compensating weight 2. Instead of a rod-shaped frame part disposed above the top end of the compensating weight 2, the tension control means 8 now comprises a frame part 8a having at least a top part of curved shape, which as viewed from the side is e.g. roughly elliptical in shape and has a longer horizontal axis than vertical axis. In this solution not so many joints or other components are needed as in the solution according to FIGS. 1 and 2. The traction member 5 is adapted to pass from the first end of the frame part 8 along the top surface of the frame part to the second end of the frame part and from there downwards to the top surface of the compensating weight 2, to which the second end of the traction means 5 is fixed. The top surface of the frame part 8a is preferably toothed when the traction member is a toothed belt. Between the first and second end of the traction member 8a, a fixing means 4a of the suspension member 4 is hinged to a suitable fixing point 15 from each end of said traction member. The fixing point 15 is selected, as stated earlier, in such a way that the desired lever ratio A/B is obtained between the suspension member 4 and the traction member 5, in which ratio the length of the lever arm A is the distance between the lifting point of the compensating weight 2 and the traction member 5 at the point 13a, where the traction member 5 detaches from the first end of the frame part 8a and descends to the machine station, and the length of the lever arm B is the distance between the lifting point of the compensating weight 2 and the fixing point 15 of the suspension member 4. This lever ratio A/B acts directly, in the manner presented above, on the magnitude of the forces exerted on the suspension members 4 and on the traction member 5.

FIG. 5 presents a simplified and diagrammatic side view of an elevator in which a further embodiment of the solution according to the invention is used. In this embodiment the layout of the elevator as well as the fixings and paths of passage of the suspension member 4 and traction member 5 are in other respects similar to those in the elevator according to FIG. 1, except for the fixing of the second end of the suspension member 4 and of the traction member 5. In this embodiment a diverting pulley 16 fitted above the compensating weight 2 functions as the tension control means 8, over which diverting pulley the traction member 5 is arranged to pass to the compensating weight 2, to the top part of which the traction member 5 is fixed at its second end. Correspondingly, the second end of the suspension member 4 is fixed in connection with the shaft of the diverting pulley 16. In this embodiment the ratio of the tension forces exerted on the suspension members 4 and on the traction member 5, i.e. the lever ratio A/B, is 2:1.

FIG. 6 presents a simplified and diagrammatic side view of an elevator in which yet another embodiment of the solution according to the invention is used. In this embodiment also the layout of the elevator as well as the fixings and paths of passage of the suspension members 4 and traction member 5 are in other respects similar to those in the elevator according to FIG. 1, except for the fixing of the second end of the suspension member 4 and of the traction member 5. In this embodiment two diverting pulleys 17 and 18 fitted above the compensating weight 2 function as the tension control means 8. In this embodiment the ratio of the tension forces exerted on the suspension members and on the traction members, i.e. the lever ratio A/B, can be adjusted to that desired by selecting the diameters of the diverting pulleys 17 and 18 suitably.

The detachment points 13a and 14a of the traction member 5 presented in FIGS. 4-6 from the tension control means 8 and the detachment point 15a of the suspension member 4 from the suspension member 8 correspond in their functions to the fixing points 13, 14 and 15 presented in FIGS. 2 and 3.

In the arrangement according to the invention the traction member 5 is fixed at one of its ends, e.g. at the end on the elevator car 1 side, with a fixing means 9 providing a spring force or a constant-tensioning force in such a way that the traction member 5 always remains sufficiently taut on the rim of the traction sheave 3a and that when the suspension members 4 of the elevator car 1 stretch and loosen, the fixing means 9 removes the elongation produced via the traction member 5 and the suspension of the suspension members 4 compensates the elongation by the aid of the tension control means 8 by keeping the elevator car 1 always on an even bearing.

The tensioning means 9 can also be disposed elsewhere than on the bottom part of the elevator car 1, depending on the suspension ratio. For example, when the traction ratio of the elevator car 1 is 2:1, below the elevator car 1 is e.g. a diverting pulley, and the traction member 5 is led from the traction sheave 3a over the top of said diverting pulley back downwards either to the floor of the elevator hoistway or to the elevator machine station, to which the first end of the traction member 5 is fixed via a tensioning means 9 providing a constant tensioning force.

It should also be noted that the different solutions presented above can be inventive features together with one or more other features of the invention.

Characteristic to the solution according to the invention is, inter alia, that tensioning of the traction member 5 is arranged on both sides of the traction sheave 3a, i.e. at the first end of the traction member 5 on the elevator car 1 side as well as at the second end of the traction member 5 on the compensating weight 2 side. At the first end of the traction member 5 in connection with the elevator car 1 is a tensioning means 9 providing a constant tensioning force, and at the second end of the traction member 5 in connection with the compensating weight 2 is a tension control means 8 enabling an adjustable lever ratio A/B.

The size of the tension control means 8, e.g. the length and position of the frame part 8a or the diameters of the diverting pulleys 16, 17, is selected in such a way that, in addition to achieving the desired lever ratio based on the masses of the compensating weight 2, elevator car 1 and load, also the traction member 5 can be disposed in a suitable location beside the compensating weight 2 on a line on which the traction member 5 is guided to travel to the diverting pulley 11 past the compensating weight 2. In this case the point 13, 13a connected to the tension control means 8 of the traction member 5 is, as viewed from above, disposed outside the area of travel formed by the cross-section of the compensating weight 2. This solution allows easier variation of the layout of the elevator.

In the solution according to the invention the tensioning forces exerted on the suspension members 4 and on the traction member 5 are smaller than with tensioning systems according to prior art and, in addition, elongations are smaller and the lever ratio automatically compensates elongations in the suspension members 4 and traction member 5. This is based on the fact that in the structure according to the invention, a force that is larger than that which comes from the combination of the lever ratio and gravity is not produced in the suspension members 4 and traction member 5. Tensioning systems that are known in the art always have more force in order to function sufficiently well.

It is obvious to the person skilled in the art that the invention is not limited solely to the examples described above, but that it may be varied within the scope of the claims presented below. Thus, for example, the suspension solutions and the structural solutions for the tension control means can also be different to what is presented above.

1. Arrangement for adjusting the tautness of a traction member of an elevator, which arrangement comprises at least an elevator car adapted to move reciprocally in an elevator hoistway and at least one compensating weight, which are for their part connected to support the elevator car by means of at least one suspension member, such as a rope or belt, and also a hoisting machine provided with at least one traction sheave or corresponding, and at least one traction member such as a belt, rope or chain, which is adapted to transmit the rotational movement of the traction sheave into movement of the elevator car and of the compensating weight, and also a tension control means, to which the suspension member and traction member are connected, and which tension control means is arranged to adjust the magnitude of the tension forces exerted on the suspension member and on the traction member, wherein the arrangement additionally comprises a tensioning means connected to the traction member, and in that the tension control means is connected to that part of the traction member that is on the side of the compensating weight with respect to the traction sheave, and the tensioning means is connected to that part of the traction member that is on the side of the elevator car with respect to the traction sheave.

2. Arrangement according to claim 1 for adjusting the tautness of a traction member of an elevator, wherein on the tension control means is the fixing point of the second end of the traction member, the horizontal distance of which fixing point from the fixing point that is in the lifting point of the compensating weight is, and in that on the tension control means is the fixing point of the second end of the suspension member, the horizontal distance of which fixing point from the fixing point that is in the lifting point of the compensating weight is, and in that the distance is smaller than or equal to the distance.

3. Arrangement according to claim 1 for adjusting the tautness of a traction member of an elevator, wherein the traction member is arranged to travel to the compensating weight over the tension control means, and in that on the tension control means is the detachment point of traction member corresponding to the fixing point of the second end of the traction member, the horizontal distance of detachment point from the detachment point corresponding to the fixing point of the compensating weight, detachment point being in the lifting point of the compensating weight, is, and in that on the tension control means is the fixing point of the second end of the suspension member, the horizontal distance of which fixing point from the detachment point is, and in that the distance is smaller than or equal to the distance.

4. Arrangement according to claim 1, for adjusting the tautness of a traction member of an elevator, wherein at the tension control means is a means providing a lever ratio, which means is arranged to divide the forces acting on the traction member and on the suspension member in the lever ratio.

5. Arrangement according to claim 1 for adjusting the tautness of a traction member of an elevator, wherein the fixing point of the suspension member in the tension control means is between the points and in the horizontal direction.

6. Arrangement according to claim 1 for adjusting the tautness of a traction member of an elevator, wherein the traction member is fixed at one of its ends to the elevator car via a fixing means providing essentially a spring force or a constant tensioning force and at the other of its ends to a tension control means that distributes the tension forces according to the lever ratio both to the suspension member and to the traction member.

7. Arrangement according to claim 1 for adjusting the tautness of a traction member of an elevator, wherein the tension control means has a rod-shaped frame part, at the first end of which is a fixing point for the traction member and at the second end of which is a fixing point for the compensating weight as well as a fixing point, between the fixing points and, for the suspension member.

8. Arrangement according to claim 7 for adjusting the tautness of a traction member of an elevator, wherein the traction member, compensating weight and suspension member are connected to their fixing points via a shaft extension or hinge.

9. Arrangement according to claim 1 for adjusting the tautness of a traction member of an elevator, wherein, as viewed from above, the point at which the traction member is connected to the tension control means is disposed outside the area of travel formed by the cross-section of the compensating weight.

10. Arrangement according to claim 1 for adjusting the tautness of a traction member of an elevator, wherein the tension control means is a diverting pulley, over which the traction member is lead to travel from the elevator car to the compensating weight and to the shaft of which diverting pulley the suspension member is connected at its second end.
